(19) United States
(12) Patent Application Publication
(10) Pub. No.: US 2008/0147901 A1
(43) Pub. Date: Jun. 19, 2008

(54) METHOD AND APPARATUS FOR INTERFACING TO AN INTEGRATED CIRCUIT THAT EMPLOYS MULTIPLE INTERFACES

(75) Inventors: Tilman Gloekler, Gaertringen (DE); Ingemar Holm, Stuttgart (DE); Ralph C. Koester, Tuebingen (DE); Mack Wayne Riley, Austin, TX (US); Shoji Sawamura, Kawasaki City (JP); Iwao Takiguchi, Tokyo (JP)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/555,076

(22) Filed: Oct. 31, 2006

(51) Int. Cl. G06F 3/00

(52) U.S. Cl. 710/11

(57) ABSTRACT

In one embodiment, the disclosed methodology and apparatus involves an integrated circuit that includes multiple interfaces. Each of the interfaces couples to a respective set of registers or storage elements on the integrated circuit. A bridge circuit on the integrated circuit switchably couples the two interfaces together such that one interface may communicate with the registers that associate with that interface as well as the registers that associate with the other interface.

### TECHNICAL FIELD OF THE INVENTION

The disclosures herein relate generally to integrated circuits, and more particularly, to testing and debugging integrated circuits to assure functionality.

### BACKGROUND

To test and debug a complex integrated circuit (IC) such as a processor, the integrated circuit may employ multiple serial service test interfaces. For example, a processor may include both a JTAG interface and an SPI interface. The JTAG interface, namely the Joint Test Action Group (JTAG) interface, uses boundary scan techniques that incorporate a shift register to communicate with each chip under test. This enables an external JTAG serial interface controller to shift input signals into, and shift output signals out of, the integrated circuit chip via an interface that includes 4 I/O pins, namely input data, output data, clock and mode control. An external JTAG serial interface controller couples to the JTAG interface to test the integrated circuit. The Serial Peripheral Interface (SPI) is another standard interface that provides the integrated circuit a second serial communication capability with a second external interface controller, namely an SPI interface controller.

An integrated circuit (IC) may include both a JTAG interface and an SPI interface to conduct different tests on the IC. In one testing technique wherein the IC is a processor, a first external serial interface controller employs one of these interfaces for bring-up testing of the IC and a second external serial interface controller employs the other interface for initialization and boot testing of the IC. “Bring-up” refers to the initial testing of newly designed integrated circuits. In the present example, the JTAG interface is useful for bring-up testing and the SPI interface is useful for initialization and booting of the processor integrated circuit. Other testing roles are also possible.

In this testing approach that employs two different chip interfaces on the same IC, two different hardware interface controllers and appropriate software support are necessary. This unfortunately results in a customized bring-up board with specialized driver software. Thus, the presence of two different interfaces on the same IC typically prevents the reuse of existing driver boards and existing software. Designing two new customized bring-up boards and corresponding customized software significantly increases the testing phase of integrated circuit design.

One solution to this problem of incorporating two interfaces on an integrated circuit is to design the integrated circuit such that each interface provides access only to the minimum set of internal registers that the respective test standards require to support the functionality desired for the interfaces. For example, if JTAG is one of the interfaces, then the designers may configure the integrated circuit such that the JTAG interface provides access to a minimum set of internal registers for JTAG debugging functionalities. Unfortunately, for debugging purposes it is desirable to have access to all internal registers. If SPI is the other interface, then the designers may configure the integrated circuit such that the SPI interface provides access to a minimum set of internal registers for a boot process.

Another known solution to this implementation problem is to essentially duplicate all of the read and write paths to all of the registers that each interface requires. Unfortunately, while this approach does work, it consumes a large amount of valuable semiconductor real estate. Another significant disadvantage of this approach is that it requires a considerable amount of additional verification effort for the resultant multiple interface integrated circuit.

What is needed is a method and apparatus that supports multiple interfaces in an integrated circuit and that addresses the problems described above.

### SUMMARY

Accordingly, in one embodiment, a method is disclosed for operating multiple interfaces on an integrated circuit. The method includes providing the integrated circuit with a first interface and a second interface. The method also includes associating first registers with the first interface and second registers with the second interface. The method further includes switchably coupling, by a bridge circuit, the first interface to the second interface such that the first interface may access both the first registers and the second registers.

In another embodiment, an integrated circuit is disclosed that includes a semiconductor die. The semiconductor die includes a first interface associated with first registers and a second interface associated with second registers. The semiconductor die also includes a bridge circuit that switchably couples the first interface to the second interface such that the first interface may access both the first registers and the second registers.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a high level block diagram of a conventional integrated circuit that includes two interfaces.

FIG. 2 shows a high level block diagram the disclosed integrated circuit that supports multiple interfaces.

FIG. 3 shows a more detailed block diagram of the disclosed integrated circuit of FIG. 2.

FIG. 4A shows timing diagrams of representative interface signal waveforms for write data operations of the disclosed multiple interface integrated circuit.

FIG. 4B shows timing diagrams of representative interface signal waveforms for read data operations of the disclosed multiple interface integrated circuit.

FIG. 5 shows a flowchart that depicts a methodology for operating the multiple interfaces of the disclosed integrated circuit.

FIG. 6 is a block diagram of an information handling system that employs the integrated circuit of FIG. 3 as a processor.

### DETAILED DESCRIPTION

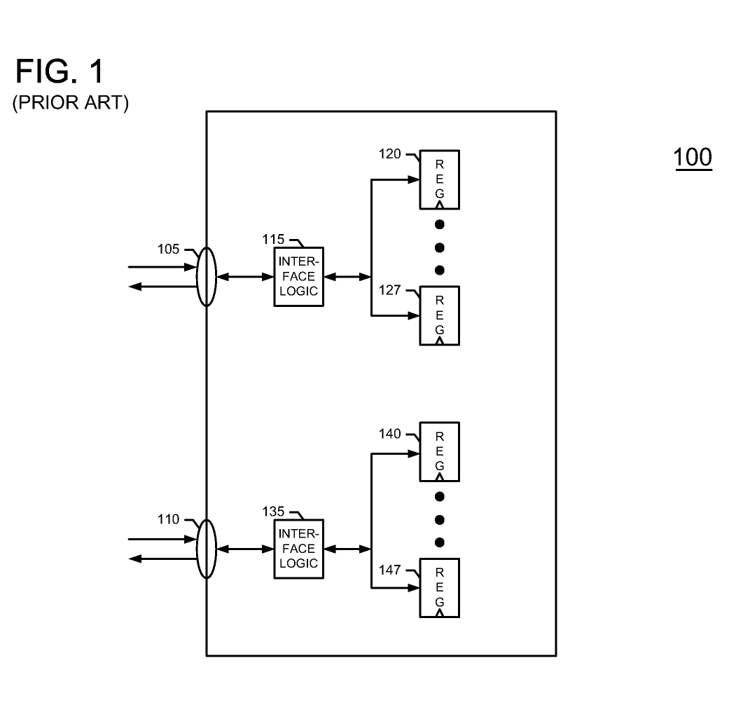

FIG. 1 shows a conventional integrated circuit (IC) 100 that includes two interfaces, namely interface 105 and interface 110. In this particular example, interface 105 is a JTAG interface and interface 110 is an SPI interface. JTAG interface 105 couples to interface logic 115 within IC 100. JTAG interface logic 115 couples to multiple registers 120-127. SPI interface 110 couples to interface logic 135 within integrated circuit 100. SPI interface logic 135 couples to multiple registers 140-147. In the conventional IC multiple interface topology that FIG. 1 illustrates, interface 105 communicates with the registers 120-127 that associate with interface 105. Interface 105 does not communicate with registers 140-147 that associate with interface 110. Conversely, interface 110 communicates with registers 140-147 that associate with interface 110. However, interface 110 does not communicate with the registers 120-127 that associate with interface 105.

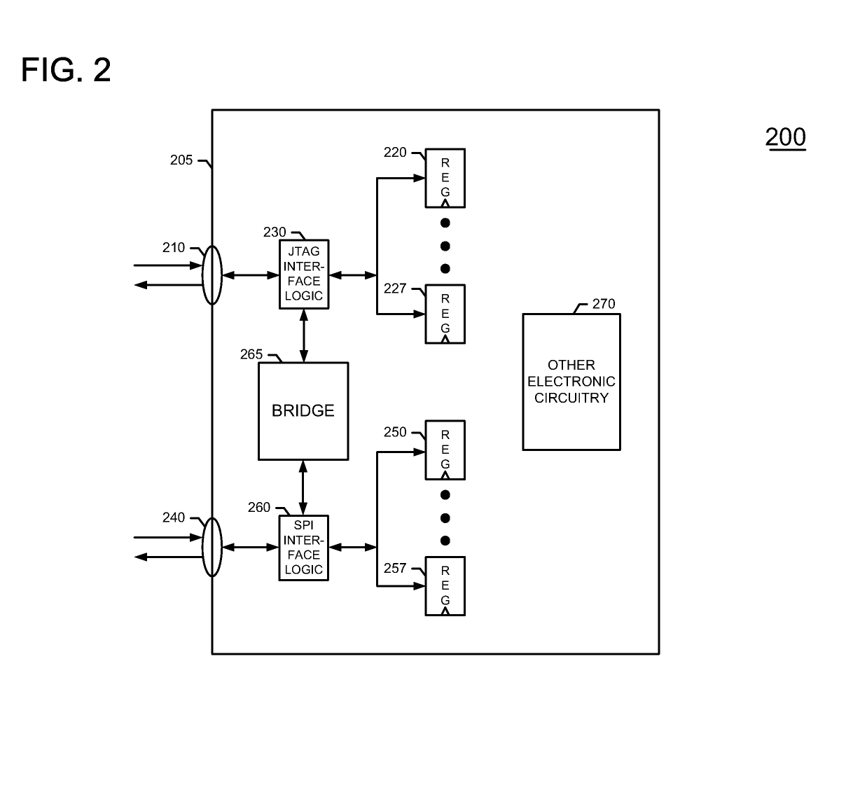

FIG. 2 is a high level block diagram of the disclosed multiple interface integrated circuit (IC) 200. IC 200 includes a semiconductor die 205 that includes the components of IC 200 discussed below. IC 200 includes an interface 210 and an interface 240. In one embodiment, interface 210 and interface 240 are different interfaces that support different serial communication protocols or standards. For example, in one embodiment interface 210 is a JTAG interface and interface 240 is an SPI interface. Interface 210 couples to registers 220-227 via JTAG interface logic 230 therebetween. In this particular embodiment wherein interface 210 is a JTAG interface, interface logic 230 is a JTAG interface slave that enables signals to communicate through interface 210 to registers 220-227. Registers 220-227 thus associate with JTAG interface 210.

Interface 240 supports a communication standard different from that of interface 210 above. For example, if interface 210 is a JTAG interface, then interface 240 may be an interface such as an SPI interface, an 12C interface (12C is a trademark of Philips Corporation) or other different interface standard. Interface 240 couples to registers 250-257 via SPI interface logic 260 therebetween. Registers 250-257 thus associate with interface 240. In an embodiment wherein interface 240 is an SPI interface, then SPI interface logic 260 is SPI interface control logic.

In one embodiment, interface 210 may communicate not only with registers 220-227 via JTAG interface logic 230, but may also communicate with registers 250-257 that associate with the different interface standard of interface 240. A bridge circuit 265 selectively couples JTAG interface logic 230 to interface SPI interface logic 260 to permit interface 210 to communicate with registers 250-257. Bridge 265 effectively operates as a switch that selectively connects or disconnects JTAG interface logic 230 to SPI interface logic 260.

When bridge circuit 265 opens, integrated circuit 200 operates in a “normal mode” wherein interface 210 communicates via JTAG interface logic 230 with its associated registers 220-227. In this normal mode, interface 240 may communicate via interface SPI interface logic 260 with its associated registers 250-257. Thus, in normal mode, each interface 210 and 240 may communicate with its associated register set, namely registers 220-227 or registers 250-257, respectively. In normal mode the interface 210, that exhibits one interface standard, does not communicate with registers exhibiting the other interface standard, namely registers 250-257.

When bridge circuit 265 closes, integrated circuit 200 operates in an “enhanced connectivity mode” or “enhanced mode” wherein interface 210 may communicate not only with its associated registers 220-227, but may also communicate via bridge circuit 265 to the registers 250-257 that associate with a different interface standard, namely interface 240. In one embodiment, when IC 200 operates in this enhanced mode, bridge circuit 265 effectively disconnects interface 240 from the internal circuitry of IC 200. Thus, in enhanced mode, interface 240 does not communicate with its associated registers 250-257 or registers 220-227.

Integrated circuit 200 includes circuitry other than the interface circuitry described above. Integrated circuit 200 may take many different forms depending on its particular functionality. For example, IC 200 may include other circuitry 270 such a single core processor, multicore processor, digital signal processor, application-specific integrated circuitry (ASIC) or other circuitry depending upon the particular application.

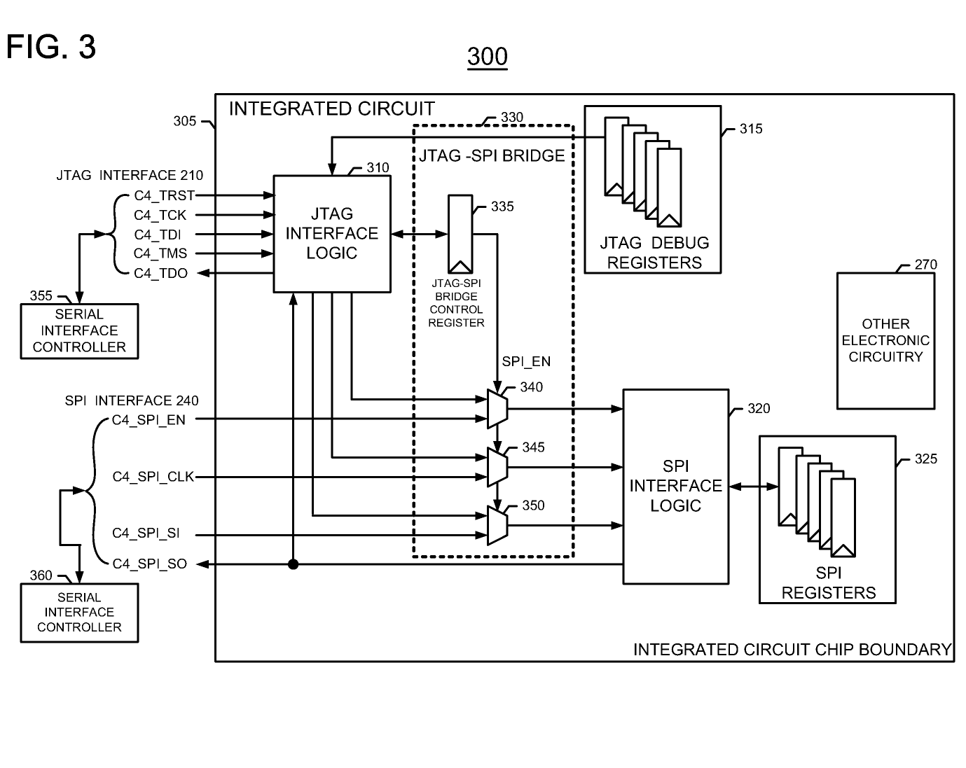

FIG. 3 is a more detailed block diagram of the disclosed integrated circuit now shown as integrated circuit 300. IC 300 includes elements in common with IC 200 of FIG. 2. In comparing IC 300 of FIG. 3 with the IC 200 of FIG. 2, like numerals indicate like elements. IC 300 includes a semiconductor die 305 on which the components thereof reside. IC 300 includes a JTAG interface 210 with an interface pinout shown below in TABLE 1:

TABLE 1
(JTAG INTERFACE 210)

| SIGNAL | FUNCTION |
|---|---|
| C4_TRST | TEST RESET |
| C4_TCK | TEST CLOCK |
| C4_TDI | TEST DATA INPUT |
| C4_TMS | TEST MODE SELECT |
| C4_TDO | TEST DATA OUTPUT |

Each of the signals that TABLE 1 depicts corresponds to a respective pin of JTAG interface 210 having the same name as the signal. The IC designer locates JTAG interface 210 adjacent the boundary or outer edge of semiconductor die 305. IC 300 also includes an interface 240 exhibiting a different communication standard than interface 210. In this particular embodiment, interface 240 is an SPI communication interface. The IC designer locates the SPI interface 240 adjacent the boundary of semiconductor 305. SPI interface 240 includes the interface pinout shown below in TABLE 2:

TABLE 2
(SPI INTERFACE 240)

| SIGNAL | FUNCTION |
|---|---|
| C4_SPI_EN | TEST ENABLE |
| C4_SPI_CLK | TEST CLOCK |
| C4_SPI_SI | TEST DATA INPUT |
| C4_SPI_SO | TEST DATA OUTPUT |

### Each of the signals that TABLE 2 depicts corresponds to a respective pin of SPI interface 240 having the same name as the signal.

IC 300 includes JTAG interface logic 310 that couples JTAG interface 210 to a group of JTAG registers 315. IC 300 further includes SPI interface logic 320 that couples SPI interface 240 to SPI registers 325 as shown in FIG. 3. Integrated circuit 300 includes a bridge circuit 330 that switchably couples SPI interface logic 320 to JTAG interface logic 310 to allow JTAG interface 210 to communicate with SPI registers 325 when integrated circuit 300 operates in enhanced mode. When integrated circuit 300 operates in enhanced mode, bridge circuit 330 effectively disconnects SPI interface 240 from SPI interface logic 320 and SPI registers 325. When operating in this enhanced mode, JTAG interface 210 may communicate with JTAG registers 315 via JTAG interface logic 310. JTAG interface 210 may communicate with JTAG registers 315 in both of IC 300's modes, namely normal mode and enhanced mode. In one embodiment, JTAG registers 315 directly connect to JTAG interface logic 310. When integrated circuit 300 operates in normal mode, JTAG interface 210 may communicate with JTAG registers 315. However in normal mode, bridge circuit 330 effectively decouples or disconnects JTAG interface logic 310 from SPI interface logic 320. In normal mode, bridge circuit 320 couples SPI interface 240 to SPI interface logic 320 and SPR registers 325. Thus, in normal mode SPI interface 240 communicates with SPI registers 325.

To enable switching from normal mode to enhanced mode and from enhanced mode back to normal mode, bridge circuit 330 includes a bridge control register 335. In one embodiment, bridge control register 335 is a one bit register that controls whether SPI interface logic 320 will receive its input from JTAG interface 210 or SPI interface 240. Control register 335 is thus a JTAG-SPI bridge control register in this particular embodiment. Bridge circuit 335 includes multiplexers 340, 345 and 350, each of which is a two input multiplexer that includes an enable line. The output of control register 335 couples to the enable line of each of multiplexers 340, 345 and 350. A serial interface controller 355 that couples to JTAG interface 210 sends a normal mode command to JTAG interface logic 310 to place a logic zero in control register 335 to switch IC 300 to normal mode. Alternatively, controller 355 may send an enhanced mode command to JTAG interface logic 310 to place a logic one in control register 335 to switch IC 300 to enhanced mode. The command that controller 355 transmits may be a command that a user manually inputs to controller 355. Controller 355 is also programmable to automatically send a normal mode command or an enhanced mode command to JTAG interface logic 310.

When JTAG interface logic 310 receives a normal mode command from JTAG interface 210, then JTAG interface logic 310 stores a logical zero in JTAG-SPI bridge control register 335 of bridge circuit 330. This causes the output of control register 335 to exhibit a logical zero. The output of control register 335 corresponds to an SPI enable signal, SPI_EN, that controls the switching state of multiplexers 340, 345 and 350. The output of control register 335 couples to the enable inputs of multiplexers 340, 345 and 350 to convey the SPI₁₃ EN enable signal thereto. Thus, when controller 355 transmits a normal mode command to JTAG interface logic 310, interface logic 310 writes a logical zero in bridge control register 335. This causes the SPI₁₃ EN signal to exhibit a logic zero that selects the lower inputs of multiplexers at 340, 345 and 350 to couple SPI interface 240 to SPI interface logic 320 and SPI registers 325. Thus, in normal mode, SPI interface input signals C4_SPI_EN, C4_SPI_CLK and C4_SPI SI pass through respective multiplexers 340, 345 and 350 to SPI interface logic 320. This provides an optional serial interface controller 360 with access to SPI registers 325 via SPI interface 240 and SPI interface logic 320. However, optional controller 360 is not required to access SPI registers 325 because JTAG interface 210 may access SPI registers 325 when IC 300 operates in enhanced mode. Regardless of mode, an output line of SPI interface logic 320, namely output line C4_SPI_SO, couples to both SPI interface 240 and the JTAG interface logic 310, as shown in FIG. 3. This enables SPI interface logic 320 to send data from SPI registers 325 to SPI interface 240 and JTAG interface 210.

When JTAG interface logic 310 receives an enhanced mode command from controller 355 via JTAG interface 210, then JTAG interface logic 310 stores a logical one in the JTAG-SPI bridge control register 335. This causes the output of control register 335 to exhibit a logic one. In response, the SPI-EN enable signal transitions to a logic one and multiplexers 340, 345 and 350 select their upper multiplexer inputs to couple to SPI interface logic 320 and SPI registers 325. Thus, when integrated circuit 300 switches to enhanced mode, JTAG interface 210 couples not only to JTAG registers 315, but also to SPI registers 325 via multiplexers 340, 345 and 350 and SPI interface logic 320. This means that controller 355 can send information to and receive information from SPI registers 325 as well as JTAG registers 315. When integrated circuit 300 operates in enhanced mode, multiplexers 340, 345 and 350 effectively decouple SPI interface 240 from SPI interface logic 320. Thus, SPI interface 240 may not access the SPI interface logic 320 and SPI registers 325 in enhanced mode. JTAG interface 210 may access its associated JTAG registers 315 in either normal mode or enhanced mode.

While the embodiment shown in FIG. 3 depicts a JTAG interface for interface 210 and an SPI interface for interface 240, any other combination of serial interfaces is usable in place of these interfaces. Examples of other standard interfaces include serial shift interfaces such as the I2C interface (I2C is a trademark of Philips Corporation), the MICROWIRE interface, (MICROWIRE is a trademark of National Semiconductor Corporation), the Maxim 3-wire interface and the Maxim/Dallas 1-wire interface. In the embodiment of FIG. 3 wherein other electronic circuitry 270 is processor or microprocessor circuitry, interface 210 is a JTAG interface and interface 240 is an SPI interface, then JTAG interface 210 is usable as a debug interface for IC 300. In this embodiment, SPI interface 240 is usable as a boot interface to load configuration data and boot code during a processor boot process.

When IC 300 and bridge circuit 330 operate in normal mode, JTAG information may flow from JTAG interface 210 to JTAG registers 215 and vice versa. Likewise, SPI information may flow from SPI interface 240 to SPI registers 320 and vice versa. However, when IC 300 and bridge circuit 330 switch to enhanced mode at the direction of controller 355, controller 355 may operate through JTAG interface 210 to access both JTAG registers 315 and SPI registers 325. To access SPI registers 325, bridge circuit 335 routes JTAG data to SPI interface logic 320. In response, SPI interface logic 320 interprets the JTAG data it receives as a regular SPI interface operation. In the case of a read operation, bridge circuit 330 routes responsive read information from SPI registers 325 back to JTAG interface 210. To achieve this functionality, IC 300 embeds shift information for the SPI interface in the data stream of the JTAG interface for both read and write operations between the JTAG interface and SPI registers 325.

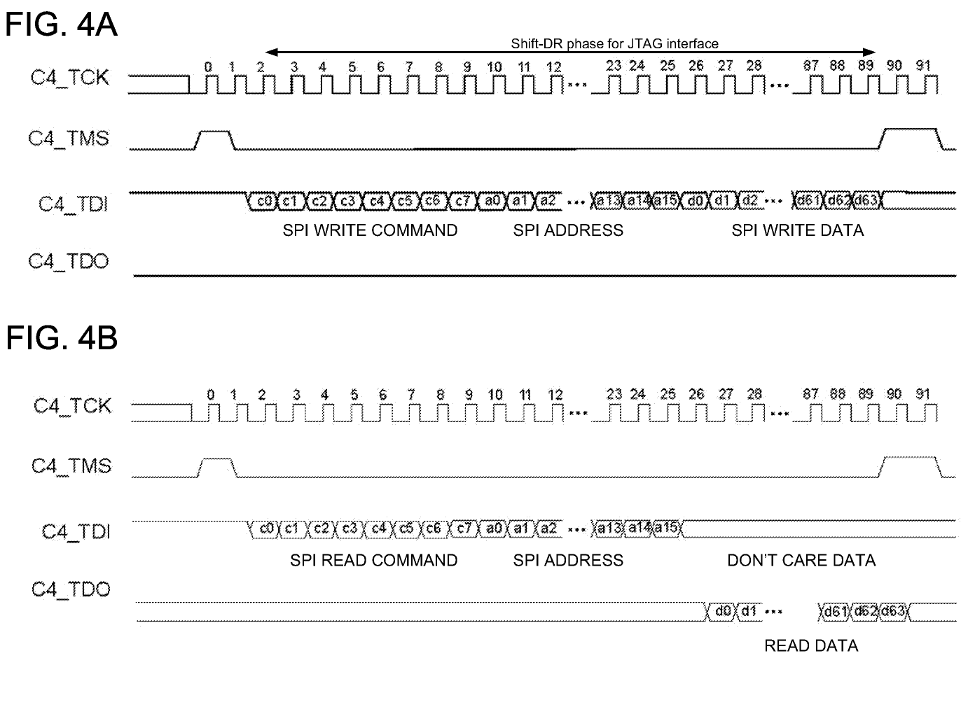

FIG. 4A and 4B show waveforms of SPI information embedded in JTAG information for write and read operations, respectively. To write SPI information to SPI registers 325 when IC 300 is in enhanced mode, controller 355 embeds SPI information in the C4_TDI data input signal of JTAG interface 210. More specifically, controller 355 embeds an SPI write command in bits c0, c1, . . . c7, embeds a target SPI write address in bits a1, a2, . . . a15, and further embeds SPI write data in bits d0, d1, . . . d63 in the C4_TDI signal of the JTAG interface 210 signals as shown in the JTAG interface waveforms of FIG. 4A. In this manner, JTAG interface logic 310 at the instruction of controller 355 embeds an SPI command and SPI data stream in the JTAG data stream. In more detail, during the “shift-DR phase of the JTAG interface” shown in FIG. 4A, controller 355 shifts the SPI write command (bits c0, c1 . . . c7), the SPI address (bits a0 to a15) and the SPI data (bits d0 to d63) into JTAG interface 210 and JTAG interface logic 310. JTAG interface logic 310 and JTAG-SPI bridge 330 routes this SPI information to SPI interface logic 320 which then executes the specified SPI write instruction.

However, to read SPI information from SPI registers 325 when IC 300 is in enhanced mode, controller 355 again embeds SPI information in the C4_TDI data input signal of JTAG interface 210. More specifically, controller 355 embeds an SPI read command in bits c0, c1 . . . c7, embeds a target SPI read address in bits a1, a2 . . . a15, and further embeds don't care data after the target SPI read address in the C4_TDI signal of the JTAG interface 210 signals, as shown in the JTAG interface waveforms of FIG. 4B. SPI interface logic 320 interprets this read command as an SPI read command and retrieves the requested SPI information at the target SPI address in SPI registers 325. SPI interface logic 320 transmits the retrieved requested information or data, d0, d1 . . . d63 on the C4_SPI_SO signal line of SPI interface 240. Because the C4_SPI_SO signal line of the SPI interface 240 couples to JTAG interface logic 310, JTAG interface logic 310 returns the requested read information to controller 355 on the C4_TDO signal line of JTAG interface 210, as the C4_TDO signal in FIG. 4B so indicates. SPI interface logic 320 sends the responsive SPI read data during DON'T CARE DATA of the SPI read command and JTAG interface logic 310 shifts the requested read data out via the C4_TDO signal line of the JTAG interface 210, as the timing diagram of FIG. 4B indicates.

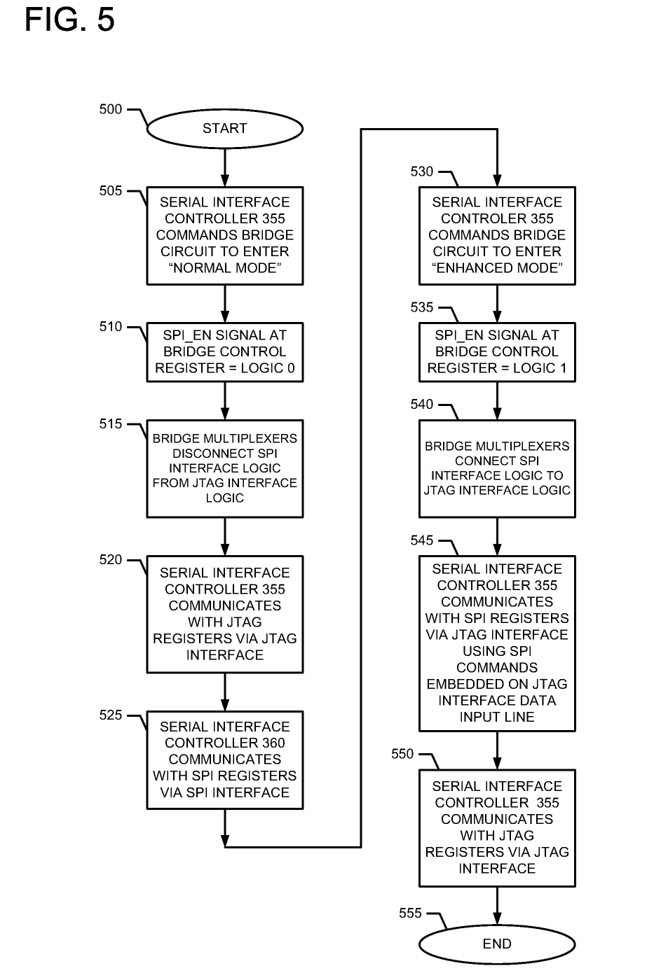

FIG. 5 is a flowchart that depicts operation of integrated circuit 300 in a normal mode wherein JTAG interface 210 communicates with JTAG registers 315 and SPI interface 240 communicates with SPI registers 325. This flowchart also depicts operation of integrated circuit 300 in an enhanced mode, wherein JTAG interface 210 communicates with both JTAG registers 315 and SPI registers 325. Integrated circuit 300 powers up and commences operation at start block 500. At this point, serial interface controller 355 may send a command via JTAG interface 210 that instructs bridge circuit 330 to operate in “normal mode”, as per block 505. In response, JTAG interface logic 310 stores a logic zero in JTAG-SPI bridge control register 335. This causes the SPI enable signal, SPI_EN, to likewise exhibit a logic zero, as per block 510. In response to the logic zero SPI enable signal, multiplexers 340, 345 and 350 effectively decouple or disconnect SPI interface logic 320 from JTAG interface logic 310, as per block 515. With integrated circuit 300 now fully configured in normal mode, serial interface controller 355 may communicate with JTAG registers 315 via JTAG interface 210 and JTAG interface logic 310, as per block 520. This communication with JTAG registers 315 may include test information such as IC debug test information, for example. While IC 300 is in normal mode, an optional serial interface controller 360 may communicate with SPI registers 325 via SPI interface 240 and SPI interface logic 320, as per block 525. This communication with SPI registers 325 may include test information such as IC initialization and boot test information, for example. Those skilled in the art will appreciate that in actual practice the order in which integrated circuit 300 performs the steps in the flowchart may be different than the flowchart shows. Moreover, integrated circuit 300 need not necessarily switch from normal mode to enhanced mode or from enhanced mode to normal mode. For example, the integrated circuit may proceed directly to enhanced mode when a user turns the system on. Alternatively, the integrated circuit may proceed directly to normal mode when a user turns the system on.

For discussion purposes, serial interface controller 355 now sends a command via JTAG interface 210 that instructs bridge circuit 330 to operate in “enhanced mode”, as per block 530. In response, JTAG interface logic 310 stores a logic one in JTAG-SPI bridge control register 335. This causes the SPI enable signal, SPI_EN, to likewise exhibit a logic one, as per block 535. In response to the logic one SPI enable signal, multiplexers 340, 345 and 350 couple JTAG interface logic 310 to SPI interface logic 320, as per block 540. This provides controller 355 with access via the JTAG interface 210 to SPI interface logic 320 and SPI registers 325. Controller 355 now communicates with SPI registers 325 via JTAG interface 210 using SPI commands that the controller 355 embeds in the JTAG input signal line C4_TDI of the JTAG interface 210, as per block 545. This communication with SPI registers 325 may include test information such as IC initialization and boot test information, for example. While in enhanced mode, controller 355 may also communicate via JTAG interface 210 with JTAG registers 315, as per block 550. This communication with JTAG registers 315 may include test information such as IC debug test information, for example. Process flow ends at end block 555. Controller 355 may repeat the process that the flowchart of FIG. 5 describes as needed.

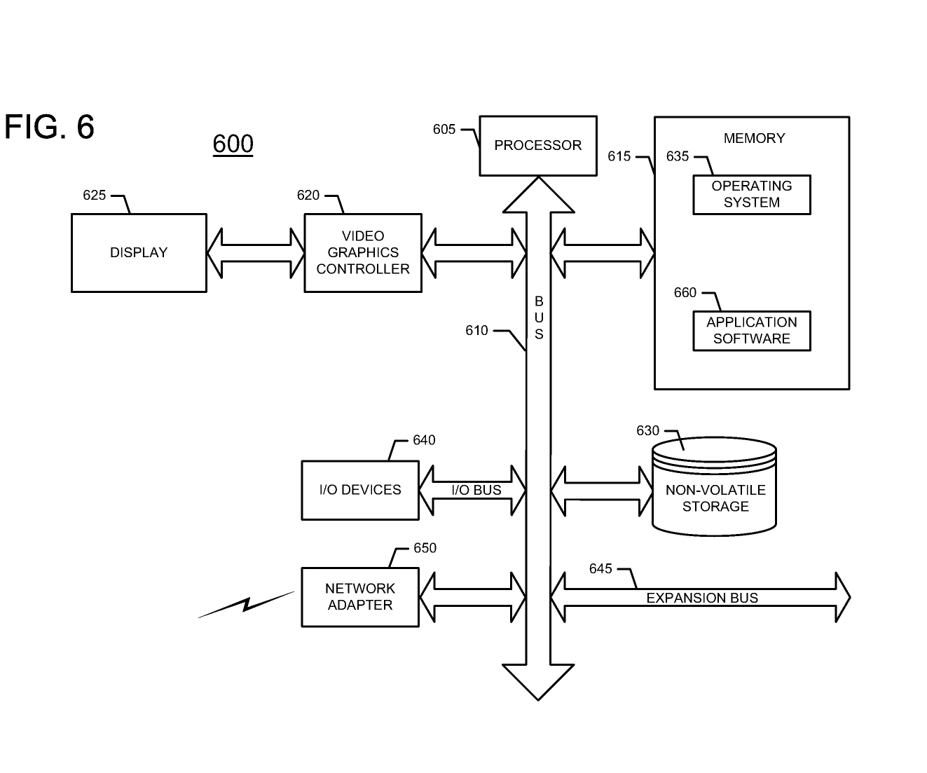

FIG. 6 shows an information handling system (IHS) 600 that includes a processor 605. In one embodiment, integrated circuit 300 of FIG. 3 is usable as processor 605 when electronic circuitry 270 is processor circuitry. Controller 355 may test both JTAG registers 315 and SPI registers 325 when IHS 600 employs integrated circuit 300 as processor 605 during IHS testing. IHS 600 further includes a bus 610 that couples processor 605 to system memory 615 and video graphics controller 620. A display 625 couples to video graphics controller 620. Nonvolatile storage 630, such as a hard disk drive, CD drive, DVD drive, or other nonvolatile storage couples to bus 610 to provide IHS 600 with permanent storage of information. An operating system 635 loads in memory 615 to govern the operation of IHS 600. I/O devices 640, such as a keyboard and a mouse pointing device, couple to bus 610. One or more expansion busses 645, such as USB, IEEE 1394 bus, ATA, SATA, PCI, PCIE and other busses, couple to bus 610 to facilitate the connection of peripherals and devices to IHS 600. A network adapter 650 couples to bus 610 to enable IHS 600 to connect by wire or wirelessly to a network and other information handling systems. While FIG. 6 shows one IHS that employs processor 605, the IHS may take many forms. For example, IHS 600 may take the form of a desktop, server, portable, laptop, notebook, or other form factor computer or data processing system. IHS 600 may take other form factors such as a gaming device, a personal digital assistant (PDA), a portable telephone device, a communication device or other devices that include a processor and memory.

In one embodiment, the disclosed integrated circuit includes a bridge circuit that couples together a JTAG interface and an SPI interface on the integrated circuit. A controller that couples to the JTAG interface may access both the JTAG interface and the SPI interface. This may simplify bring-up and verification of a newly designed IC such as a processor or other electrical circuit on the IC. The term “verification” means verifying hardware, such as the disclosed IC, in a simulation environment before the hardware really exists, i.e. before the hardware is actually manufactured. “Bring-up” is the test of the real, manufactured and assembled system hardware including, for example, different integrated circuit chips, memories and boards in interaction with written and developed systems' software and firmware. In one embodiment, bring-up boards for a previous IC are reusable to test the disclosed IC. This simplifies the bring-up environment and decreases cost and development time.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, while the representative integrated circuit 300 of FIG. 3 includes two different interfaces, the teachings herein apply as well to integrated circuits including 3 or more interfaces. In such embodiments, the designer may increase the number of inputs that the multiplexers of bridge circuit 330 employ to accommodate the additional interfaces. Persons skilled in the art may also substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of operating multiple interfaces on an integrated circuit, the method comprising:
providing the integrated circuit with a first interface and a second interface;
associating first registers with the first interface and second registers with the second interface; and
switchably coupling, by a bridge circuit, the first interface to the second interface such that the first interface may access both the first registers and the second registers.

2. The method of claim 1, wherein the switchably coupling step includes a first mode wherein the bridge circuit decouples the first interface and the second interface.

3. The method of claim 2, wherein during the first mode the first interface couples to the first registers and the second interface couples to the second registers.

4. The method of claim 2, wherein the switchably coupling step includes a second mode wherein the bridge circuit couples the first interface to both the first registers and the second registers.

5. The method of claim 4, wherein during the second mode the bridge circuit decouples the second interface from the second registers.

6. The method of claim 2, further comprising transmitting, by an interface controller, test information to the first interface during the first mode.

7. The method of claim 2, further comprising transmitting, by an interface controller, test information to the first interface during the second mode.

8. The method of claim 7, wherein the test information is one of debug test information and boot test information.

9. An integrated circuit, comprising:
a semiconductor die including:
a first interface associated with first registers;
a second interface associated with second registers; and
a bridge circuit that switchably couples the first interface to the second interface such that the first interface may access both the first registers and the second registers.

10. The integrated circuit of claim 9, wherein the bridge circuit operates in a first mode to decouple the first interface and the second interface.

11. The integrated circuit of claim 10, wherein during the first mode the first interface couples to the first registers, and the bridge circuit couples the second interface to the second registers.

12. The integrated circuit of claim 10, wherein the bridge circuit operates in a second mode to couple the first interface to both the first registers and the second registers.

13. The integrated circuit of claim 12, wherein during the second mode the bridge circuit decouples the second interface from the second registers.

14. The integrated circuit of claim 10, further comprising an interface controller, coupled to the first interface, that transmits test information to the first interface during the first mode.

15. The integrated circuit of claim 10, further comprising an interface controller, coupled to the first interface, that transmits test information to the first interface during the second mode.

16. The integrated circuit of claim 15, wherein the test information is one of debug test information and boot test information.

17. An information handling system, comprising:
a memory;
a processor integrated circuit (IC), coupled to the memory, the processor IC including:
a first interface associated with first registers;
a second interface associated with second registers; and
a bridge circuit that switchably couples the first interface to the second interface such that the first interface may access both the first registers and the second registers.

18. The information handling system of claim 17, wherein the bridge circuit operates in a first mode to decouple the first interface and the second interface.

19. The information handling system of claim 18, wherein during the first mode the first interface couples to the first registers, and the bridge circuit couples the second interface to the second registers.

20. The information handling system of claim 18, wherein the bridge circuit operates in a second mode to couple the first interface to both the first registers and the second registers.
